(19) United States
(12) Patent Application Publication
(10) Pub. No.: US 2014/0144039 A1
(43) Pub. Date: May 29, 2014

(54) Dryer Tennis Shoe Stickker

(71) Applicant: Marvin Lee Jackson, Los Angeles, CA (US)

(72) Inventor: Marvin Lee Jackson, Los Angeles, CA (US)

(21) Appl. No.: 13/562,413

(22) Filed: Jul. 31, 2012

Related U.S. Application Data
(63) Continuation-in-part of application No. 12/798,826, filed on Jun. 11, 2010, now abandoned.

(51) Int. Cl. F26B 25/08

(52) U.S. Cl. CPC F26B 25/08
USPC 34/239

(57) ABSTRACT

I have invented a partly magnetic apparatus to facilitate the drying of athletic shoes in a conventional laundry dryer while dryer is in motion of consisting stretchable band and rod.

A partly magnetic apparatus that is slightly bent upwards on each opposite end with permanent rectangular casing and magnet on each opposite end to improve the drying of athletic shoes in a conventional laundry dryer.

Apparatus is to be placed on bottom center of tennis shoe lengthwise by a stretchable band that will go around the center mouth area of tennis shoe and magnetic apparatus. Apparatus is to be magnetically attached to curvature of dryer drum.

Rod will be rectangular and is to be placed in upper lacing area of shoe widthwise to keep upper mouth area of shoe opens for superior drying results. When drying is complete, simply remove shoe and apparatus from dryer drum with caution.

### BRIEF DESCRIPTION OF DRAWING

FIG. 1 is a view of partly magnetic apparatus (2) is a view of shoe stuck to dryer drum with band (80).

FIG. 2 is a view of stretchable band (80) around bottom (13) of apparatus (2) and shoe.

FIG. 3 is a view of rectangular rod in upper mouth area of shoe. And band around center mouth area of shoe and apparatus.

FIG. 4 is a view of partly magnetic apparatus (2) and shoe stuck to dryer drum with band (80).

FIG. 5 and FIG. 5A is side and bottom (9) and back and front view of partly magnetic apparatus (2) slightly bent upward on each opposite bottom end (9).

FIG. 6 and FIG. 6A is an upper view (13) of apparatus (2) bent upward on each opposite and also a back and front and side view.

FIG. 7 and FIG. 7A is a view of rectangular rod.

FIG. 8 and FIG. 8A is a view of stretchable band (80).

### DISCUSSION OF BACKGROUND

For the better part of the 20^{th} century, athletic shoes have been in use all over the world. Most households have at least one pair. They require little maintenance, and only require washing and drying every so often. Laundering athletic shoes requires nothing special; they can be air-dried or put in the dryer. However, when using a dryer, shoes tumble and bounce loudly, creating a noisy nuisance and potentially causing damage to the dryer and shoe. For this reason, most people prefer to air-dry their athletic shoes, which can take a long time.

I believe there is need for a device that allows the drying of athletic shoes in laundry dryer without creating excess noise or risk damage.

What is claimed is:

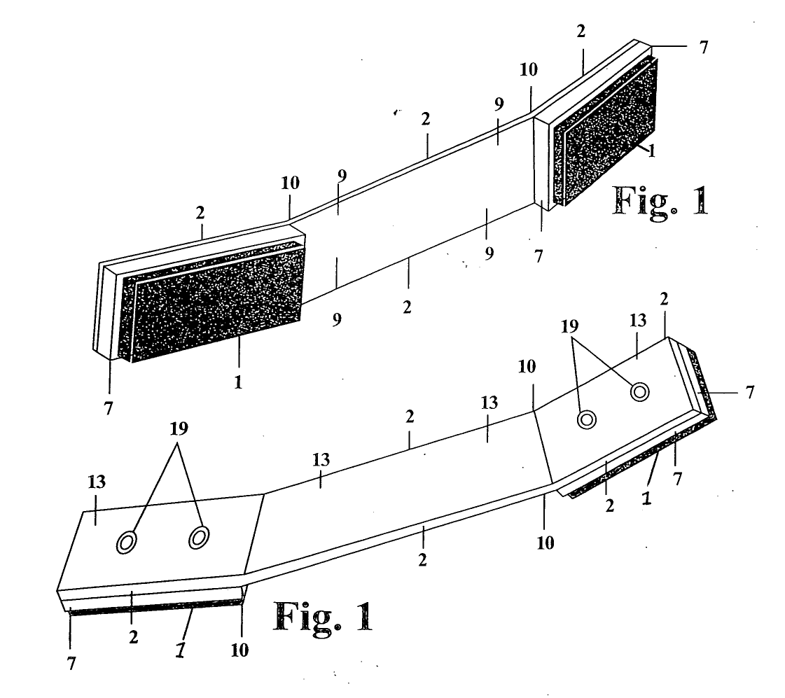

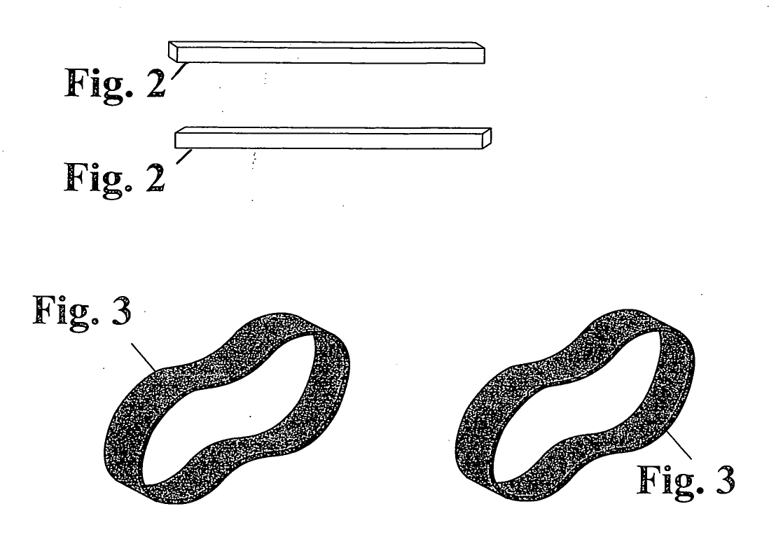

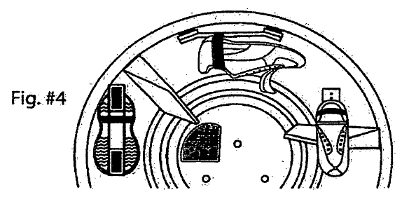

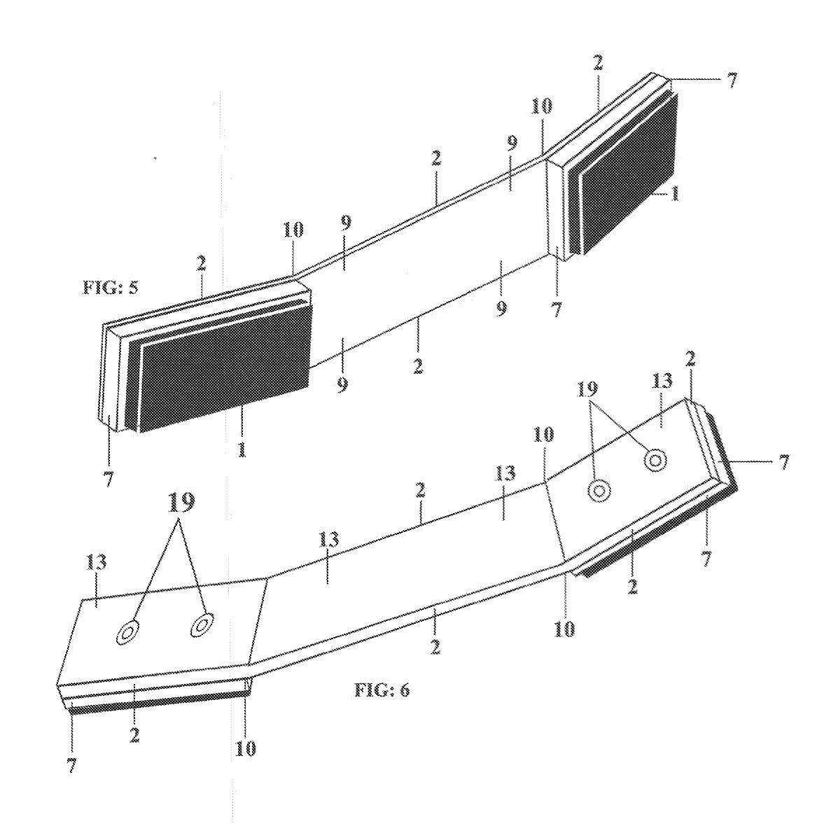

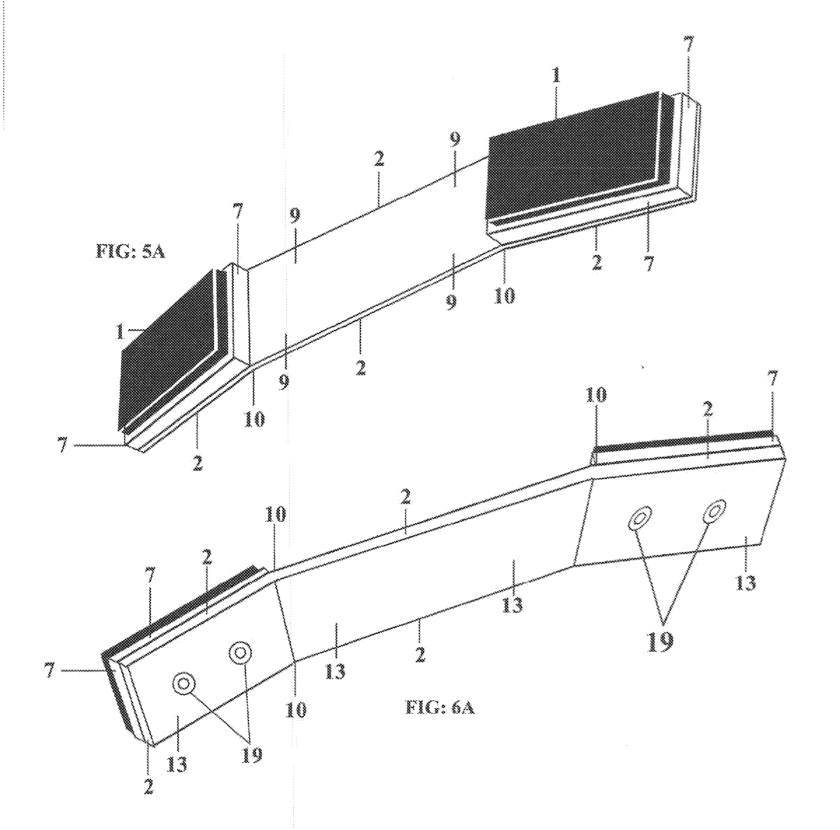

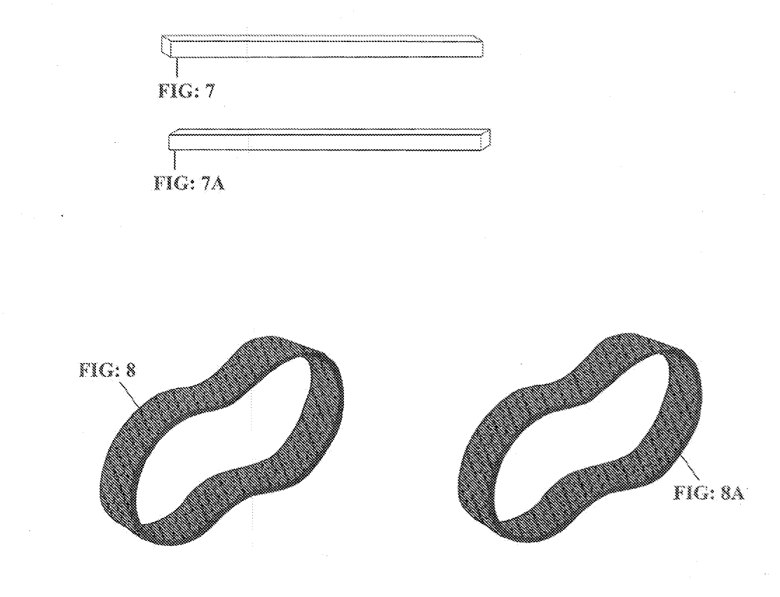

1. A partly magnetic apparatus (2) of claim #1: Apparatus (2) will be slightly bent upwards (10) on each opposite end. Apparatus (2) will have at least one permanently attached rectangular casing (7) and rectangular magnet (1) on each end of apparatus (2). Apparatus (2) of claim #2 will have a length of 9 to 14 inches. Will have a width ½ to 1 inch. The area between the casing (7) and magnet (1) will have a thickness of 0.25 mm to 1M mm. Where casing (7) and magnet (1) are located and apparatus (2) combined will have a thickness of ½ to 1 inch. Rectangular magnets (1) will be partly permanently wedged down into rectangular casings (7). Casings (7) will be permanently attached by rivets (19). Apparatus (2) will have a partly flat upper surface (13). It will also have a partly flat bottom surface (9) between casings (7) and magnet (1). Apparatus (2) and casing (7) can be of all solid, slightly flexible material or not. Apparatus (2) is to be attached to curvature of dryer drum (55). Rectangular rod of claim #2: Rod will have a length of 1 to 6 inches, a width of ½ to 1 mm, and a thickness of ½ to 1 mm. Stretchable band (80) of claim #3: Band (80) (80a) will have a length of 1 to 6 inches, a thickness of ½ to 1 mm, and a width of ½ to 1 inch. Band (80) can be made of all stretchable or non-stretchable fabrics. Magnet (1) can be made of all powerful magnetic materials such as metallic and ceramic magnets (1) sold and manufactured. Apparatus (2) of claim #1 will be rectangular. Rod (14) of claim # 3: Rod (14a)(14) will be rectangular made of all slightly flexible or non-flexible materials. Apparatus (2) FIG. 1 and apparatus casing (7) and rectangular magnet (1) on each opposite bottom (9) and of apparatus (2).
